(19) United States
(12) Patent Application Publication
(10) Pub. No.: US 2008/0236286 A1
(43) Pub. Date: Oct. 2, 2008

(54) Non-destructive tubular testing

(76) Inventors: Clive Chemo Lam, Tomball, TX (US); Yanming Guo, Houston, TX (US)

Correspondence Address: Guy McClung;#114, 5315-B F.M., 1960 Rd. West, Houston, TX, 77069-4410, US

(21) Appl. No.: 11/729,989

(22) Filed: Mar. 29, 2007

(51) Int. Cl. G01N 29/04

(52) U.S. Cl. 73/618

(57) ABSTRACT

A shoe apparatus for a tubular inspection, the shoe apparatus including a body, a circuit board attached to the body, a film on the backing body, the film made of piezoelectric material, a plurality of ultrasonic transducers on the film, and each ultrasonic transducer of the plurality of ultrasonic transducers connected to the circuit board.

### BACKGROUND OF THE INVENTION

1. Field Of The Invention

The present invention is directed to the non-destructive testing of tubulars and, in certain particular aspects, to systems and methods for such testing which employ ultrasonic transducers with a polyvinylidenefluoride piezoelectric film.

2. Description of Related Art

Non-destructive testing of tubulars can indicate flaws in the tubular. The prior art includes a wide variety of systems and methods for the non-destructive testing of tubulars; e.g., but not limited to, the systems and methods disclosed in U.S. Pat. Nos. 5,063,776; 5,616,009; 5,975,129; 7,055,623; 5,715,861; 4,638,978; and in U.S. application Ser. No. 11/098,166 filed Apr. 04, 2005 (co-owned with the present invention), all patents and the application listed incorporated fully herein for all purposes.

In certain prior art methods ultrasonic beams generated by transducers can not cover the full body of a tubular under test; and in other prior methods in which the ultrasonic beams generated by all the transducers can cover the full body of the tubular under test, mechanical rotation of either the scanning head or the tubular has to be facilitated, or a high number of individually packaged transducers is used, which can lead to complicated system design, high cost, and difficulty of operation.

The present invention recognizes the problems and disadvantages of certain prior art systems and methods. The present invention provides reliable, relatively low-cost, and accurate systems and methods for the non-destructive testing of tubulars.

### BRIEF SUMMARY OF THE PRESENT INVENTION

The present invention, in at least certain embodiments, discloses systems and methods which employ a plurality of spaced-apart ultrasonic transducers made with polyvinylidenefluoride (“PVDF”) (and its copolymers) piezoelectric films for measuring tubular wall thickness and/or detecting flaws.

In certain aspects of inspection systems according to the present invention with such transducers a tubular passing through an inspection system is not rotated and the transducers are not rotated.

When a mechanical stress, e.g. a stress due to an ultrasonic wave, is applied to a PVDF film which has two electrodes, each on a different surface of the film, the film that receives the wave generates a measurable electric voltage between electrodes on two surfaces. When an electric voltage is applied to the PVDF film through the electrodes, a mechanical strain is generated resulting in the generation of an ultrasonic wave. These two effects are combined in a PVDF ultrasonic transmitter-receiver (“transducer”) useful in systems and methods according to the present invention. PVDF films with electrodes and ultrasonic transducers with PVDF films are commercially available.

In certain particular aspects, the present invention provides systems and methods for measuring tubular wall thickness and for detecting defects with a plurality of PVDF ultrasonic transducers attached to and spaced apart around a body (e.g. a hollow cylindrical body or a hollow conical body, e.g. with at least one, two, three or more PVDF films) through which a tubular is movable (e.g., but not limited to oilfield tubulars; e.g., but not limited to risers, casing, tubing, pipe, drill pipe, mechanical tubing, boiler tubing, and drill collars) whose wall thickness along its entire length is to be measured or whose entire body is to be scanned for defects. Each separate PVDF ultrasonic transducer is electrically connected to a computerized control system with control electronics or a circuit board which is in communication with such a control system.

In certain aspects, between the PVDF transducers and an outer tubular surface is a coupler, e.g. an ultrasonic coupling agent, e.g. water. The PVDF transducers are excited by high voltage pulses produced by the control system to generate ultrasonic waves that propagate to the tubular through the coupling agent. In the case of a hollow cylindrical body, the propagation direction of the ultrasonic waves is perpendicular to the outer and inner surfaces of the tubular. The ultrasonic waves are reflected by both surfaces and go back to the PVDF transducers. The reflection from the outer surface is commonly called interface echo. The reflection from the inner surface is commonly called back wall echo Inside the tubular wall, the ultrasonic waves can also be reflected back and forth numerous times before their energy dies down, giving rise to multiple back wall echoes. The interface echo and the back wall echo or echoes are used to measure the tubular wall thickness since the time between two adjacent echoes is proportional to the thickness. In the case of a hollow conical body, the propagation direction of the ultrasonic waves is in an angle with the normal of the outer and inner surfaces of the tubular. The ultrasonic waves are reflected back to the PVDF transducers by defects, such as cracks, in the tubular wall. The returned waves are used to detect such defects. The control system communicates with (control, activates or excites; and/or detects return signals) the transducers.

The body, e.g. a hollow cylindrical or conical body, is a whole integral piece or it is two or more separate pieces. There can be one or more PVDF ultrasonic transducers on each PVDF film. In certain particular aspects of systems according to the present invention, multiple PVDF ultrasonic transducers positioned adjacent to each other are communicated with via a control system and excited at the same time, or each is communicated with and excited in order with a well defined delay pattern to form a composite wave, equivalent to one produced by a single PVDF transducer occupying the same area by the multiple transducers. The composite wave is used to obtain wall thickness measurements. Then a next group of transducers, i.e., one or more transducers from above and one or more transducers next to them, are excited in the same way to form another second composite wave that is partially overlapping with the first composite wave and the second composite wave is used to measure the tubular wall again. Multiple composite waves can also be formed at different circumferential locations of the tubular at the same time. By forming composite waves around the tubular, the system obtains wall thickness measurements and flaw detection for the entire surface of the tubular without any gaps and without mechanically rotating either the tubular or the transducers.

The present invention, in certain aspects, discloses a shoe apparatus for tubular inspection, the shoe apparatus including a body, a film on the body, the film made of piezoelectric material, a plurality of ultrasonic transducers on the film, and each ultrasonic transducer of the plurality of ultrasonic transducers.

Accordingly, the present invention includes features and advantages which are believed to enable it to advance non-destructive tubular inspection technology. Characteristics and advantages of the present invention described above and additional features and benefits will be readily apparent to those skilled in the art upon consideration of the following detailed description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide:

New, useful, unique, efficient, non-obvious systems and methods for non-destructive tubular inspection;

Such systems and methods which use one or more ultrasonic transducers with PVDF piezoelectric film.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1A is a perspective view of a system according to the present invention.

FIG. 1B is a front view of part of the system of FIG. 1A.

FIG. 1C is a cross-section view of the part of the system of FIG. 1B.

FIG. 2A is a top view of a PVDF film for use with the system of FIG. 1A.

FIG. 2B is a partial end view of the film of FIG. 2A.

FIG. 2C is an enlargement of part of the film of FIG. 2A.

FIG. 2D is an end view of a PVDF film for use in the system of FIG. 1A.

FIG. 2E is a perspective view of part of a system as in FIG. 1A.

FIG. 2F is a front view of part of a system according to the present invention.

FIG. 2G is a front view of part of a system according to the present invention.

FIG. 3A is a perspective view of a system according to the present invention.

FIG. 3B is a front view of part of the system of FIG. 3A.

FIG. 3C is a front view of part of the system of FIG. 3A.

FIG. 3D is a perspective view of the system of FIG. 3A mounted to a frame.

FIG. 3E is an end view of the system of FIG. 3D.

Presently preferred embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference.

### DETAILED DESCRIPTION OF THE INVENTION

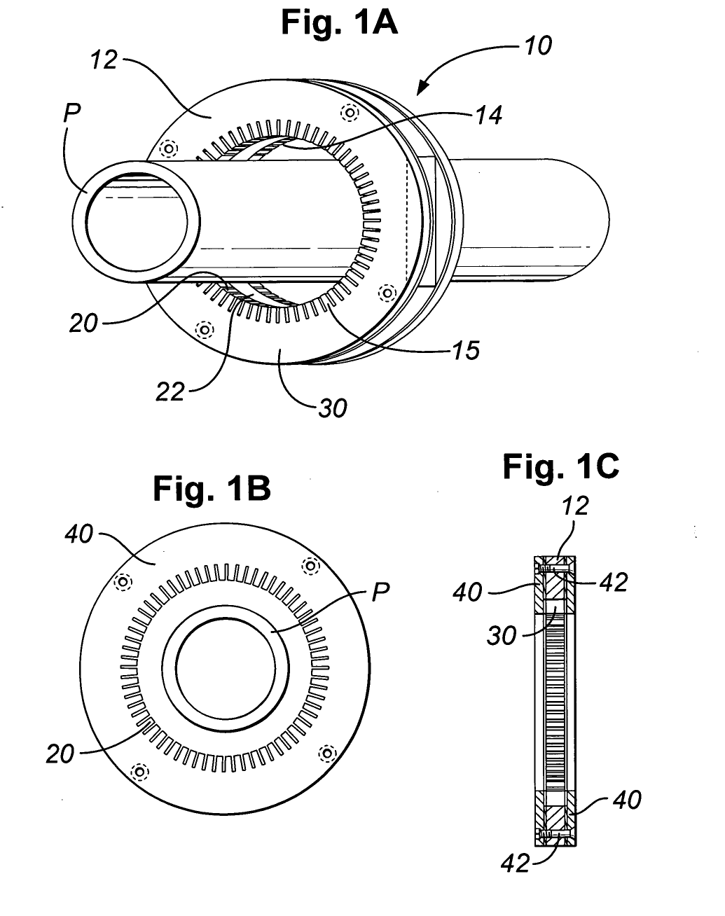

FIG. 1A shows a system 10 according to the present invention which has a generally cylindrical body 12 (or “shoe”) with a channel 14 through which a pipe P to be tested is movable. A plurality of PVDF ultrasonic transducers 20 are spaced-apart around the circumference of the channel 14. PVDF film 22 covers the interior of the channel 14 and each transducer 20 includes a strip or finger of this film. The PVDF film 22 can be one or more pieces, each of which has patterned electrodes on its top and bottom surfaces to form multiple transducers. For example, but not limited to, the pattern can be an array of rectangular electrodes with small gaps between them. The area where the top electrode and the bottom electrode fully overlap defines an active area of each transducer 20. The top electrodes can be used as the ground electrodes and then the bottom electrodes are the signal electrodes, or vice versa. A coupler 16 adjacent the body and interposed between the transducers and a tubular to be inspected provides coupling for the transducers and maintains stand off between the tubular and the transducers as the tubular moves through the body 12.

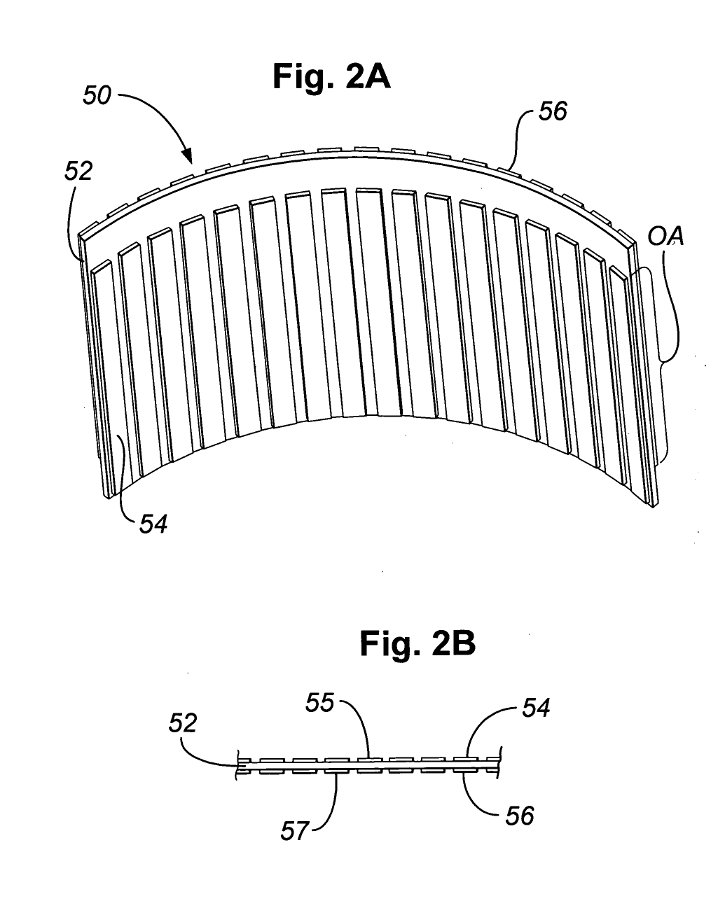

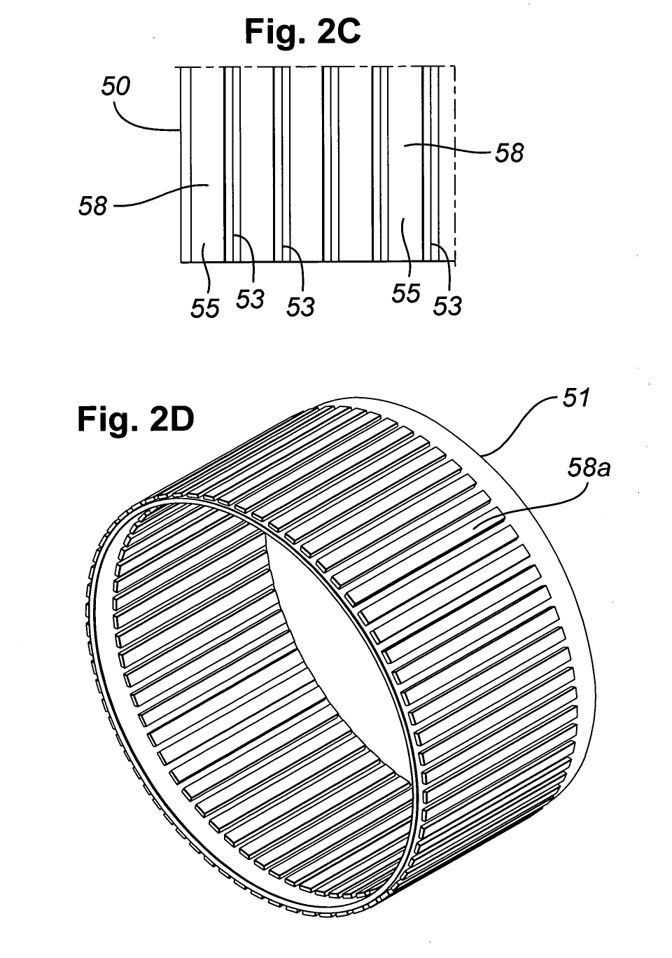

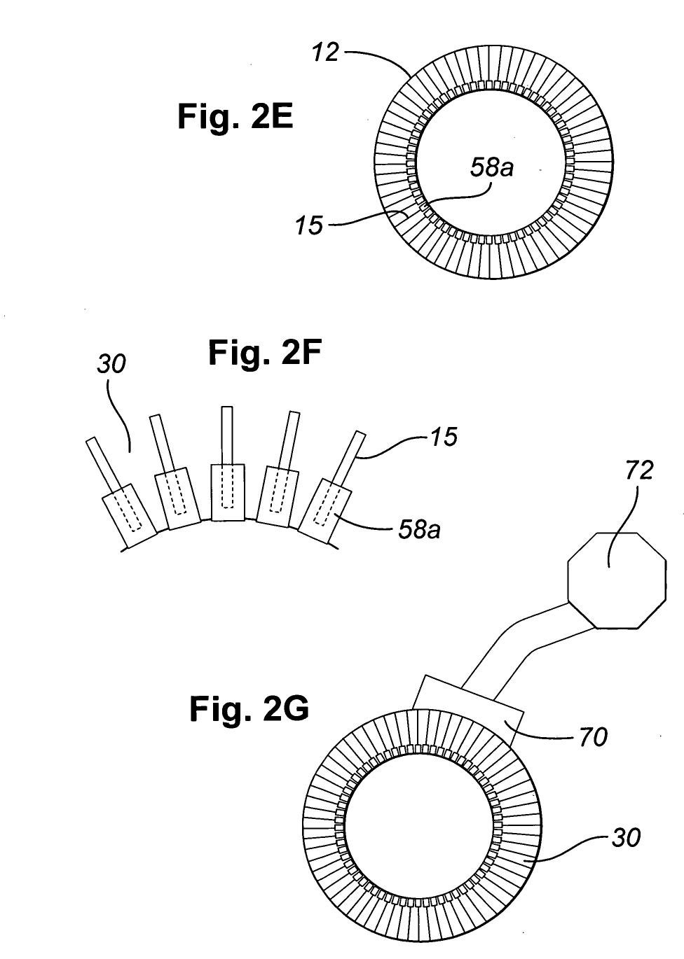

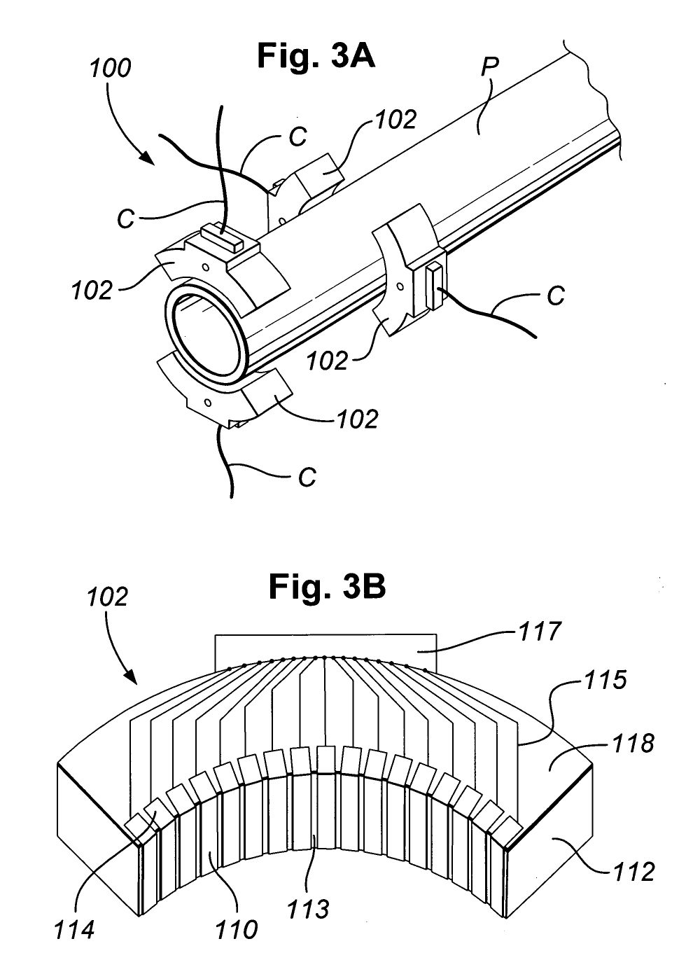

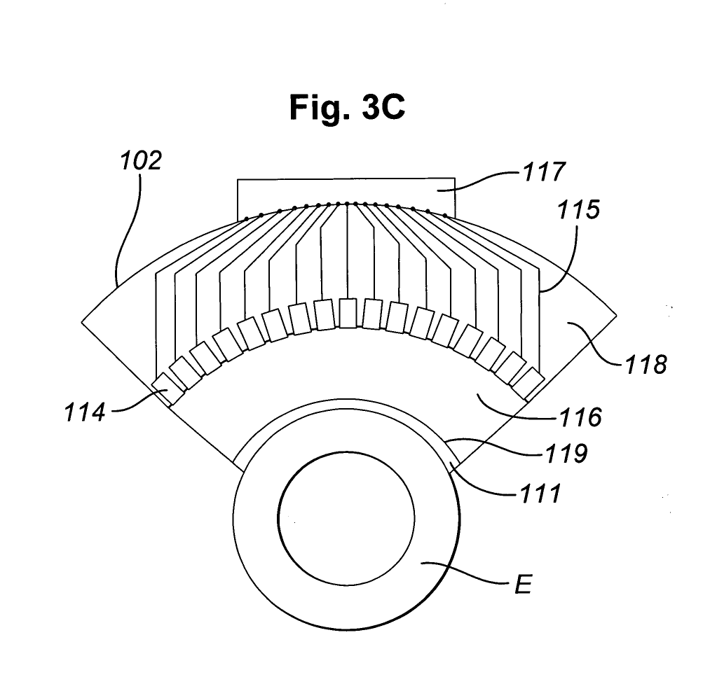

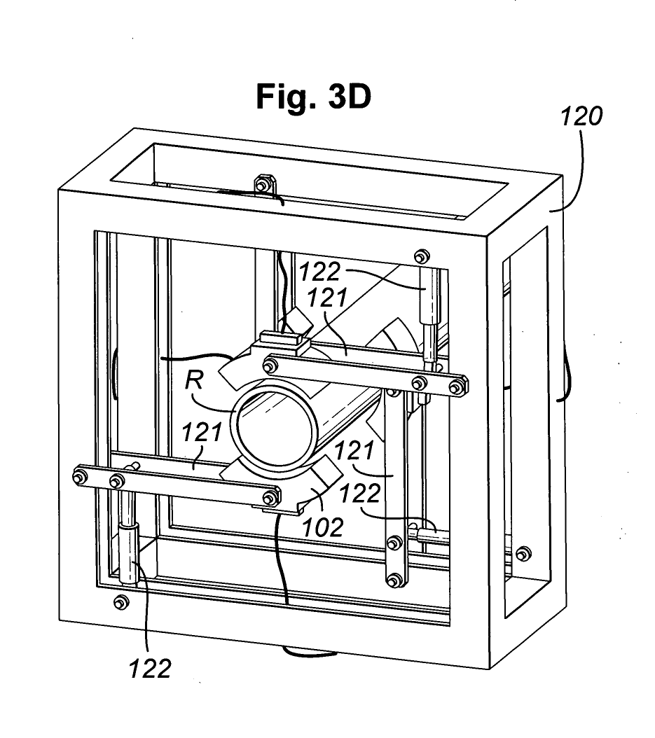

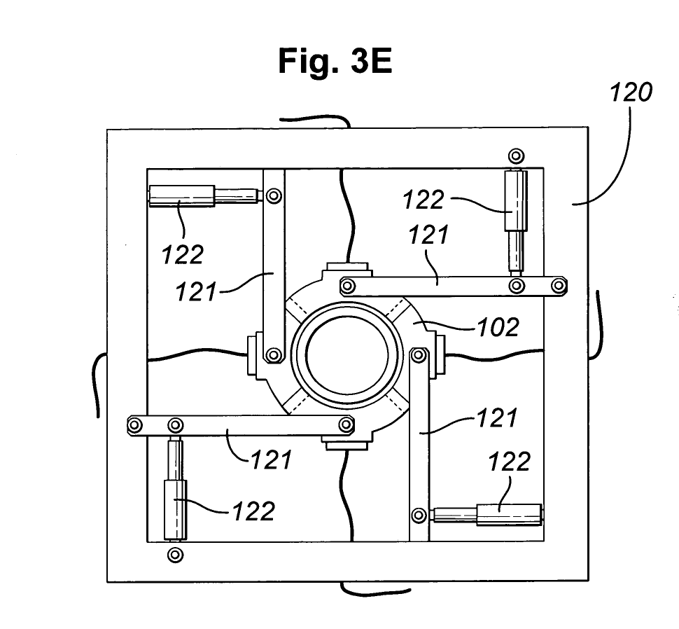

Each transducer 20 corresponds to a portion 15 of the body 12 and is connected directly to control electronics or, e.g. as shown connected to a printed circuit board (“PCB”) 30. A ground electrode of each transducer is connected to a ground plane of the PCB 30, and its signal electrode is connected to a signal trace on the PCB 30 (see traces 15, FIGS. 2E, 2F, and traces 115, FIG. 3B). “Traces” are formed on a circuit board by depositing or “printing” a thin layer of conductive material on the board's surface to connect individual electronic components. Plates 40 outside each board 30 are bolted together with bolts 42 that pass through the test body 12. In one aspect the plates 40 are made of aluminum (but may be made of e.g. steel or copper or any non-conducting material). The body 12 is made, e.g., of LUCITE (trademark) material or any suitable plastic, metal, rubber, or polyester.

FIG. 2A shows a PVDF piezoelectric film 50 which has a base 52 made of PVDF; a top layer 54 of spaced-apart rows 55 of electrodes; and a bottom layer 56 of spaced-apart rows 57 of electrodes (see FIG. 2B). The top electrodes 55 and the bottom electrodes 57 overlap partially. The overlapped area (e.g. the area OA, FIG. 2B) defines the active area of a transducer, and the non-overlapped areas (e.g. at the ends) are used for electrical connection that can be achieved by, e.g., but not limited to, mechanically pressing the non-overlapped ends of the film 50 onto the PCB 30 so that the electrodes are in direct contact with the traces of the PCB (see traces 15, FIGS. 2E, 2F, and traces 115, FIG. 3B) or directly attaching connectors or wires to the non-overlapped ends of the film 50. Typical thicknesses of commercially available PVDF films include 9 μm, 25 μm, 52 μm, and 110 μm, though other thicknesses can be used. In certain aspects, electrodes are made of conductive inks, paints, tapes, or vacuum deposited metals.

As shown in FIG. 2C, the film 50 is cut (lines 53) between the rows 55, 57 (either from end to end or only at the ends) to form strips or fingers 58 that are folded over the spaced-apart traces of the boards 30 to achieve electrical connections.

FIG. 2D shows a piece of PVDF piezoelectric film 51 (not to scale) with strips 58a formed into a cylinder for insertion into a channel like the channel 14 and attachment to the wall of the channel using an adhesive. The cutting lines 53 are parallel to the axis of the cylinder. Each strip 58a is a PVDF ultrasonic transducer 20 whose top ground electrode is connected to the ground plane of the PCB 30 and whose bottom signal electrode is connected to a signal trace of the PCB 30. The test body 12 behind the film 51 acts as a backing material for the transducer. The top of the film 51 can be coated with acrylics, adhesives, synthetic rubber resins, epoxies and/or cyano-acrylates, etc., to prevent corrosion and oxidation of the electrodes.

As shown in FIG. 2E, the film 51 is positioned within a test body 12 so that when the ends of the strips 58a are folded over on the PCB 30 they line up with the signal traces 15 of the PCB 30. As shown in FIG. 2F, a strip 58a is folded over a signal trace 15 of the PCB 30.

FIG. 2G illustrates a primary connection 70 connecting the PCB board 30 to a control system 72. All the signal traces 15 on the PCB 30 are connected to the primary connection 70 and, thus, all the ultrasonic transducers, defined by the strips 58a, are connected to the control system 72. The control system 72 can excite one transducer by generating and delivering high voltage pulses to it and take wall or flaw measurement from the signal received by it subsequently, then move to the next transducer. In one aspect this leaves a gap between two successive measurements because there is a gap between the ultrasonic beams produced by two adjacent transducers. The control system can also excite multiple adjacent transducers at the same time or with a well defined delay pattern to form a composite wave, equivalent to one produced by a single PVDF transducer occupying the same area by the multiple transducers, and take wall or flaw measurements from the summed signal received by the same group of the transducers, then move to a next group of adjacent transducers to form a new composite wave that is partially overlapped with the previous composite wave. This eliminates the gaps caused by exciting a single transducer at a time, resulting in a full coverage of the entire circumference and area of the pipe.

FIG. 3A shows a system 100 according to the present invention like the system 10, but with a plurality of distinct offset test shoes 102 (or “shoe segments”). The test shoes 102 are partially overlapped (e.g. overlap as indicated by dotted lines in FIG. 3E) to fully cover the entire circumference of the pipe P being tested. FIG. 3B shows internal components of a test shoe 102. A PVDF film 113 is attached to the inner cylindrical surface of a backing material 112 by an adhesive. The PVDF film 113 has a plurality of ultrasonic transducers 110 on it. Each PVDF film 113 and its ultrasonic transducers 110 are made as shown in FIG. 2A. The end strips 114 of each ultrasonic transducer 110 are cut and folded over the signal traces 115 on a PCB 118 that is mounted to the side of the backing material 112. The end strips 114 and the signal traces 115 are electrically connected. The signal traces 115 are connected to a connector 117 mounted on the PCB 118. The shoes 102 are electrically connected to a control system (like the control system of FIG. 2G) through the connectors 117 via cables C. Like the system 10, the control system can excite one transducer or a group of adjacent transducers to form a single wave or a composite wave and take wall measurement, then move to the next transducer or a next group of transducers.

FIG. 3C shows a side view of a test shoe 102 with its inside exposed, in the axial direction of a test pipe E below it. Although the figure shows the test shoe 102 in direct contact with the pipe E, it could be spaced-apart from the pipe. With the test shoe 102 in direct contact with the pipe E, it sits on and conforms to the outer surface of the pipe E. Immediately below the PVDF film is a water compartment 116. The water compartment 116 is open from the bottom or sealed by an acoustically transparent membrane 119. The water compartment 116 provides water coupling for the ultrasonic transducers and maintains stand off between the transducers and the pipe when the pipe moves through the system in the axial direction. If the water compartment 116 is open, it is filled continuously with running water. If the water compartment 116 is sealed, only the gap 111 between the membrane 119 and the outer surface of the pipe E is filled continuously with running water.

FIG. 3D shows a plurality of test shoes 102 mounted to a frame 120 through movable arms 121 and an actuating mechanism 122 (e.g., but not limited to, air cylinders). The arms 121 bring the shoes down to the pipe or move them off a pipe R. For example, when the pipe R is moved into the system in the axial direction, the actuated arms 121 bring the shoes toward the pipe to start testing and hold the shoes around the pipe while testing is in progress. When the pipe is about to leave the system, the actuated arms move the shoes away from the pipe. FIG. 3E is an end view of the system in FIG. 3D.

Accordingly, while preferred embodiments of this invention have been shown and described, many variations, modifications and/or changes of the system, apparatus and methods of the present invention, such as in the components, details of construction and operation, arrangement of parts and/or methods of use, are possible, contemplated by the patentee, within the scope of the appended claims, and may be made and used by one of ordinary skill in the art without departing from the spirit or teachings of the invention and scope of appended claims. Thus, all matter herein set forth or shown in the accompanying drawings should be interpreted as illustrative and not limiting, and the scope of the invention and the appended claims is not limited to the embodiments described and shown herein.

The present invention, therefore, provides in at least certain embodiments, a shoe apparatus for tubular inspection, the shoe apparatus including: a body; a film on the body, the film made of piezoelectric material; and a plurality of ultrasonic transducers on the film. Such a shoe apparatus may have one or some (in any possible combination) of the following: wherein the body is generally cylindrical and has a channel therethrough through which a tubular to be inspected is passable; a control system, each ultrasonic transducer in communication with the control system; wherein the control system controls any individual ultrasonic transducer, a series of adjacent ultrasonic transducers, or a plurality of series of adjacent ultrasonic transducers; a coupler for propagating ultrasonic waves from the ultrasonic transducers to a tubular to be inspected, the coupler adjacent the body for interposition between the body and a tubular to be inspected; the shoe is a plurality of individual shoes which are movable together to form a channel through which a tubular to be inspected is passable; movement apparatus for moving each individual shoe segment; each individual shoe segment overlaps an adjacent shoe segment; wherein the plurality of ultrasonic transducers are spaced-apart around the channel; a circuit board attached to the body, and each ultrasonic transducer connected to the circuit board; wherein the body is generally cylindrical and the body is generally cylindrical and the plurality of ultrasonic transducers are spaced-apart around the generally cylindrical body; wherein each ultrasonic transducer includes a portion of the film with a top surface, a bottom surface, a top electrode on the top surface, a bottom electrode on the bottom surface, each electrode connected to the circuit board; and/or a control system, each ultrasonic transducer in communication with the control system via the circuit board.

The present invention, therefore, provides in at least certain embodiments, a method for inspecting a tubular, the method including introducing the tubular into a shoe apparatus for inspecting tubulars, the shoe apparatus as any disclosed herein according to the present invention, controlling the ultrasonic transducers with a control system of the shoe apparatus, and activating ultrasonic transducers of the shoe apparatus using the control system to generate ultrasonic waves directed to the tubular to inspect the tubular. Such a method may have one or some (in any possible combination) of the following: wherein a body of the shoe apparatus is generally cylindrical and has a channel therethrough through which the tubular passes and wherein there is a plurality of ultrasonic transducers spaced-apart around the generally cylindrical body, the method further including with the control system, communicating with individual ultrasonic transducers to inspect the tubular; wherein the body is generally cylindrical and has a channel therethrough through which the tubular passes and wherein the plurality of ultrasonic transducers are spaced-apart around the generally cylindrical body, the method further including with the control system, communicating with a plurality of ultrasonic transducers to form a composite wave to inspect the tubular; wherein each of the plurality of ultrasonic transducers is used simultaneously; wherein each of the plurality of ultrasonic transducers is used in order according to a defined delay pattern; wherein the tubular has a circumference and a generally cylindrical body and has a channel through the body for tubular passage, and wherein the plurality of ultrasonic transducers are spaced-apart around the generally cylindrical body, the method further including activating pluralities of adjacent ultrasonic transducers to form a plurality of multiple composite waves around the tubular's circumference to inspect the entire tubular; and/or inspecting the tubular with the shoe apparatus without rotating the tubular and/or without rotating the ultrasonic transducers.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. This specification and the claims that follow are in accordance with all of the requirements of 35 U.S.C. §112. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes.

What is claimed is:

1. A shoe apparatus for tubular inspection, the shoe apparatus comprising
a body,
a film on the body, the film made of piezoelectric material, and
a plurality of ultrasonic transducers on the film.

2. The shoe apparatus of claim 1 wherein the body is generally cylindrical and has a channel therethrough through which a tubular to be inspected is passable.

3. The shoe apparatus of claim 1 further comprising
a control system,
each ultrasonic transducer in communication with the control system.

4. The shoe apparatus of claim 3 wherein the control system controls any individual ultrasonic transducer, a series of adjacent ultrasonic transducers, or a plurality of series of adjacent ultrasonic transducers.

5. The shoe apparatus of claim 1 further comprising
a coupler for propagating ultrasonic waves from the ultrasonic transducers to a tubular to be inspected, the coupler adjacent the body for interposition between the body and a tubular to be inspected.

6. The shoe apparatus of claim 1 wherein
the shoe comprises a plurality of individual shoes which are movable together to form a channel through which a tubular to be inspected is passable.

7. The shoe apparatus of claim 6 further comprising
movement apparatus for moving each individual shoe segment.

8. The shoe apparatus of claim 6 wherein
each individual shoe segment overlaps an adjacent shoe segment.

9. The shoe apparatus of claim 8 wherein the plurality of ultrasonic transducers are spaced-apart around the channel.

10. The shoe apparatus of claim 1 further comprising
a circuit board attached to the body, and
each ultrasonic transducer connected to the circuit board.

11. The shoe apparatus of claim 10 wherein the body is generally cylindrical and the plurality of ultrasonic transducers are spaced-apart around the generally cylindrical body.

12. The shoe apparatus of claim 10 wherein each ultrasonic transducer includes a portion of the film with a top surface, a bottom surface, a top electrode on the top surface, a bottom electrode on the bottom surface, each electrode connected to the circuit board.

13. The shoe apparatus of claim 10 further comprising
a control system,
each ultrasonic transducer in communication with the control system via the circuit board.

14. A method for inspecting a tubular, the method comprising
introducing the tubular into a shoe apparatus for inspecting tubulars, the shoe apparatus comprising a body, a circuit board attached to the body, a film on the body, the film made of piezoelectric material, a plurality of ultrasonic transducers on the film, a control system, and each ultrasonic transducer of the plurality of ultrasonic transducers connected to the circuit board, and in communication with the control system via the circuit board,
controlling the ultrasonic transducers with the control system, and
activating the ultrasonic transducers using the control system to generate ultrasonic waves directed to the tubular to inspect the tubular.

15. The method of claim 14 wherein the body is generally cylindrical and has a channel therethrough through which the tubular passes and wherein the plurality of ultrasonic transducers are spaced-apart around the generally cylindrical body, the method further comprising
with the control system, communicating with individual ultrasonic transducers to inspect the tubular.

16. The method of claim 14 wherein the body is generally cylindrical and has a channel therethrough through which the tubular passes and wherein the plurality of ultrasonic transducers are spaced-apart around the generally cylindrical body, the method further comprising
with the control system, communicating with a plurality of ultrasonic transducers to form a composite wave to inspect the tubular.

17. The method of claim 14 wherein each of the plurality of ultrasonic transducers is used simultaneously.

18. The method of claim 14 wherein each of the plurality of ultrasonic transducers is used in order according to a defined delay pattern.

19. The method of claim 14 wherein the tubular has a circumference and the body is generally cylindrical and has a channel therethrough through which the tubular passes, and wherein the plurality of ultrasonic transducers are spaced-apart around the generally cylindrical body, the method further comprising
activating pluralities of adjacent ultrasonic transducers to form a plurality of multiple composite waves around the tubular's circumference to inspect the entire tubular.

20. The method of claim 14 further comprising
inspecting the tubular with the shoe apparatus without rotating the tubular and without rotating the ultrasonic transducers.
